(19) United States
(12) Patent Application Publication
(10) Pub. No.: US 2018/0116138 A1
(43) Pub. Date: May 3, 2018

(54) VERTICAL INDOOR ECO-SYSTEM

(71) Applicant: Philemon Fung, Markham (CA)

(72) Inventor: Philemon Fung, Markham (CA)

(21) Appl. No.: 15/565,331

(22) PCT Filed: Apr. 11, 2016
(86) PCT No.: PCT/CA2016/000105

§ 371 Date: Oct. 10, 2017

(30) Foreign Application Priority Data
Apr. 9, 2015 (GB) 1506059.3

(51) Int. Cl. A01G 31/06; A01K 63/00; A01K 63/04; A01G 7/04; A01K 63/06

(52) U.S. Cl. CPC A01G 31/06; A01K 63/003; A01K 61/10; A01G 7/045; A01K 63/06; A01K 63/042

(57) ABSTRACT

The vertical indoor ecosystem invention is an indoor vertical modular structure and method. The system includes at least one: retention tank, grow bed, grow tank, structural frame, recycling water supply, light energy supply and control units. Each grow tank supports both terrestrial and/or semi-aquatic plants and fresh water aquatic species. The grow tanks are built in to the structural frame in multi-level vertical tiers connected horizontally and/or vertically. The lowermost retention tank regulates water quantity and quality and typically houses larger aquatic species. Generally, the waste water from the retention tank travels up through a water pump to the top grow bed to filter water. Water travels down to the next lower level grow tank by gravity wherein plants uptake nutrients. Water returns to retention tank in a cyclical manner.

### INCORPORATION BY REFERENCE

The inventor hereby incorporates by reference the whole of the priority application namely GB provisional application #1,506,059.3, filed Apr. 9, 2015.

### FIELD OF THE INVENTION

The indoor ecosystems of the invention combine aspects of aquaculture and hydroponics. Conventional aquaculture is the controlled farming of aquatic organisms, whereas hydroponics is the system of growing plants with cycling water and a medium other than soil. The waste produced from the aquatic organisms is converted into soluble nutrients by beneficial microbes to be taken up by the roots of the plants. The circulating water is then filtered, providing a suitable environment for the aquatic species to survive in. Generally aquaponic systems are a closed-loop circulation system.

### BACKGROUND AND PRIOR ART

Aquaponics is a system of aquaculture in which the waste produced by farmed fish or other aquatic animals supplies nutrients for plants grown hydroponically, which plants in turn purify the water in a cycling system.

Most prior art>aquaponic=systems are designed to grow and cultivate various terrestrial and/or semi-aquatic plant species (described in this specification as plants) and various fresh water aquatic species for commercial or individual use. By the theory of aquaponics, higher levels of nutrients are retained within the system that can be used for increased plant growth, thus increasing productivity.

Currently, systems built for indoor settings do not combine fish and plants in one tank. Combining fish or other fresh water aquatic species with plants typically results in the plant roots being eaten and therefore are not typically practiced. Generally, indoor>aquaponic=systems have only one container for one kind of freshwater fish species.

Current grow beds use porous media that are typically limited in being heavy and/or having limited biological space for beneficial microbes to grow and live in. Heavy porous media can cause stress in a vertical system and potentially collapse. Low biological surface area for microbes to reside in also reduces the productivity of an ecosystem and increase both the weight and size of the system.

Indoor>aquaponic=systems typically reduce real-estate footprint significantly as they are laid out horizontally. As well, horizontal>aquaponic=systems indoors typically have a less visually appealing installation.

### OBJECTS OF THE INVENTION

The system and method of the VIES invention, as depicted and described herein, is aimed at mitigating these shortcomings by providing an emulated vertical ecosystem structure and method. The VIES invention uses minimal indoor real-estate footprint with its vertical indoor space occupancy and is not limited to: residential buildings, commercial buildings, and institutions, of all sorts, in all temperate climates. The invention is also aesthetically pleasing, and compatible in all indoor spaces and economical to manufacture, supply, install and use on a permanent basis.

The new VIES system also reduces the limitations of conventional outdoor environments. This allows for year-round harvesting, particularly eliminating northern climate restrictions. The system does not require additional heating or cooling outside of control units. The system uses glass, which significantly reduces the possibility of volatile organic compounds leeching into the system. Glass also allows better clarity for viewing and monitoring of the aquatic species raising both utility and appeal.

In the grow bed component a charcoal substance created by pyrolysis of biomass called>biochar=is used in conjunction with porous material. Biochar is a lightweight natural material that contains immense amounts of biological surface area. This permits the proliferation of beneficial microbes that will further help with the mineralization of waste material and reduces overall mass of the grow bed.

The new vies system is aimed at enabling the combination of both fresh water aquatic species (henceforth including but not limited to: fish, crustaceans, mollusks, and the like) and plants (henceforth include but not limited to: terrestrial, semi-aquatic, edible, ornamental, and the like) in one multi-level system. Multiple species can exist in the system, while maintaining the quality of growth.

It is also an object of the invention to assist in a geriatric care centre. Elderly people may feel confined in a care centre and may have physical and mental ailments that may limit them from basic human functions. It is an object of the vies system to expose those staying at a care centre to nature in an indoor setting and provide a tool to allow residents to have a sense of independence and self-sufficiency by being able to grow plants and food. As well, people in wheel chairs or people who cannot bend benefit from this multi-level vertical ecosystem.

### SUMMARY OF THE INVENTION

In the described vies system, perforated containers, compartments and beds protect plant roots from damage by feeding aquatic species. This allows plant and aquatic species to not only be in one system, but also live in the same tank using vertical space reducing footprint and cost. The fish also help eliminate the deposits from the plants and growing media, lessening the cleaning and maintenance issue with the plant growing apparatus.

The vies system is a vertical modular system and method designed for scalability according to the indoor setting and requirements from parties of interest. It is composed of multi-tiered tanks forming single or multiple modules.

The new vies system is designed to mimic a sustainable ecosystem. The nitrogen cycle is a natural process that occurs in functioning ecosystems. Proper cycling allows beneficial nitrifying bacteria to grow and exist in the system. The waste material, which is typically fish waste, becomes ammonium. Nitrifying bacteria converts ammonium into nitrites and then into useful nitrates. Plants uptake the nutrients, thus purifying the water. This allows the water to be recycled.

Water goes through a filtration material which allows nitrifying bacteria to breed and grow in the system, as well as filter out larger solids. This ensures adequate bacteria in the system and provides a means of solid waste management. This system is designed for minimal input and up-keep, functioning substantially in a closed-loop system.

The described vies system permits the ability to grow food and support ornamental species. Plants and aquatic species can be closely monitored and controlled for the quality and quantity. The varieties can easily be changed and adapted. Being indoors, the system also significantly reduces pest exposure which also eliminates the need for any pesticides or herbicides.

The as-described Vertical Eco System includes at least one; retention tank, grow bed, grow tank, vertical structural frame, recycling water supply, light energy supply and control units.

The tanks containing the aquatic species may be any appropriate shape and material, but the preferred embodiment is a rectangular tank made out of glass similar to conventional aquariums.

The retention tank forms the integral part of the interconnected circulation system as it serves as the principle control tank. The retention tank contains at least one: aquarium water heater, aquarium water pump, aquarium air pump and freshwater aquatic species. Larger edible aquatic species such as tilapia are preferentially kept in the retention tank. Larger ornamental fishes such as koi are also recommended to be kept in the retention tank. These fish are, in the present embodiment, fed oil-free fish pellets daily by an automatic fish feeder, but can be altered to other feeding methods. The retention tank also serves as a reservoir to hold excess water.

To remove solid waste produced by both aquatic species and plants, the preferred manner of removal is through the grow bed. The grow bed inhibits solid waste from sinking and remaining at the bottom of the tank.

The grow bed also acts as a breeding ground for beneficial nitrifying bacteria.

The presence of biochar in the grow bed greatly increases the biological surface area for beneficial microbes to flourish. Additional decomposers may be added such as red wiggler worms, to further break down the solid waste into mineralized nutrients. The grow bed is placed at the top-tiered aquarium tank where water will be directly pumped into. Plants that need more support in particular, can also grow in the grow bed, making it not only a filtration system.

The described grow tank acts as the container for the plant growing hydroponic raft and at least one freshwater species. Each grow tank mimics an eco-system. Thus, the described system can include multiple ecosystems.

The hydroponic raft may be any suitable apparatus that supports plants for growth in hydroponic systems and may be fixed or floating in the present vies system. In one embodiment raft apparatus is capable of resting on top of each grow tank. Holes are made to fit net pots which are suspended in tank water.

Within each grow tank underneath the aquaponic raft, at least one freshwater aquatic species such as goldfish, minnow, shrimp, etc., may reside in grow tanks. Separate tanks may accommodate different sizes. It is possible for docile species to co-exist in the same tank. Non-toxic perforated containers are used to guard plant roots which may be independently supported or suspended from the raft. Aquatic species in grow tanks in the present embodiment can be hand-fed, e.g daily, or feeding can be automated.

The addition of an appropriate mechanical filter aids in further filtering of waste material. This mechanical filter can be of any acceptable design that is effective at removing waste and working synergistically with the ecosystem.

The present design allows the provision of a closed loop vies ecosystem, in which expulsion of waste is minimal, with the majority of waste being recycled through the system. Grow lights located above the grow tanks are connected to a timer mechanism set to mimic a natural day and night environment indoors.

### Water Flow

The described vies ecosystem and method is in its inactive state when the water pump located in the retention tank is switched off, e.g by the timer settings on the timer mechanism. The aquarium water heater and submersible air pump are typically kept on, to maintain water temperature and quality.

When the system is active, the timer mechanism turns on the aquarium water pump. Water from the retention tank is pumped up by way of the water supply tube to the grow bed on the highest tier. Supply water flows into and over the grow bed and from the bed to the remainder of the upper tank and thus is filtered. Perforated holes in the water supply line permit even distribution of water over much of the surface of the grow bed, preferably from the rear, as by spray or cascade. Water then flows through the grow bed and into the front area of the tank (where fresh water species can reside) and through the input water tube. Any overflow from the grow bed flows in to the upper tank.

The supply water flows then through the front area towards the opposite side of the grow tank to be drained at the outlet water tube, moving to the next lower tier grow tank by gravity. The outlet tube attached to the outlet hole in the grow tank in its present embodiment is a dual standing drain tube. It generally draws water from the bottom of the tank and moves it up to the top of the standing drain and then down to the next grow tank by gravity. The dual drain tube also has an opening at the top to prevent siphoning and to allow water to overflow from the top of the tank if the bottom drain is clogged. The drain tube can be configured differently in other embodiments.

Water then, preferably, flows through any kind of acceptable filter to further remove additional waste, and flows back to the retention tank. This process continues in the same manner. The water is then recycled through the system.

In a variant of the vies ecosystem and method, the vertical stack includes a pair of grow tanks each similarly constructed with supply water flowing from the uppermost of the pair to the lowermost and thence to the retention tank.

In a further variant of the vies ecosystem and method, the upper tank includes an upstanding grow bed including a dry layer which is wetted with supply water but not permanently submerged and a wet layer at or within the water level of the upper tank. Preferably the grow bed occupies a large portion of the upper tank and is supported at the bottom thereof with a water permeable partition separating the grow bed from the front portion. Most preferably, the partition is a near solid barrier with perforations at or towards the bottom of the tank.

In a still further variant, a top earth module is included in the grow bed, in which earth worms are provided. The worms serve to decompose fish waste from the bottom retention tank. The earth module has a dry bed, including hydrotons and biochar. The biochar increases the surface area for worms to do their work. This variant assists in enabling the middle tank to become an intensive planting module.

Alternatively, the grow tank may include a hydroponic raft retaining plants above the water level but for submerged root structures, hydroponic growth material and perforated protective cups for each of or groups of the individual plants.

### BRIEF SUMMARY OF THE DRAWINGS

The aspects, features and advantages of the described system are more readily apparent through these figures, wherein:

FIG. 1 shows the top tier grow tank with the grow bed attachment in operation. The grow bed adds filtration and biological surface area for beneficial microbial activity. Freshwater species reside in the front-third of the tank.

FIG. 2 shows the 2^{nd} tier grow tank with the hydroponic raft variant. Each grow tank typically houses both plants and freshwater aquatic species together. In FIG. 2 the plants are supported by the hydroponic raft in net pots. Root guards are shown as floating or suspended from the raft but may be fixed. Input water is supplied by gravity from the outlet of the grow tank of FIG. 1.

FIG. 3 shows the retention tank, which acts as the control module and typically houses larger freshwater aquatic species and may not include plants.

FIG. 4 shows a small indoor environment vies set up, shown without water recirculating lines. Additional grow tanks, as per FIG. 1 or 2 may stacked vertically or horizontally above the retention tank.

FIG. 5 is a side view of the vies system of FIG. 4, which illustrates the supply and return tubing that is typically placed behind a vies set up.

FIG. 6 shows a larger indoor environment vies set-up based upon the structure shown in FIGS. 4 and 5. FIG. 6 illustrates the connection of a vertical stack with more than a single horizontal component or a horizontally elongated component, but preferably with a single retention tank.

FIG. 7 provides a water flow diagram for the vies system of the invention as shown in FIG. 4 which illustrates the flow of water from the retention tank, moving up to the grow bed for filtration. Water flows down to the next tier grow tank where mineralized nutrients will be taken up by plants. Water then flows through an additional filter until it reaches back to the retention tank.

FIG. 8 shows a sectional elevation through the grow bed of FIG. 1. The grow bed with at least 50% biochar adds filtration and biological surface area for beneficial microbial activity. Plants are also able to grow in the media fill.

FIG. 9 shows a detailed pictorial view of the perforated containers shown in FIG. 2 that guard the plant roots of each plant. The perforations allow plants to absorb water and nutrients. The porous media allows additional beneficial bacteria to grow, and gives the plant support.

### DETAILED DESCRIPTION OF THE PREFERRED EMBODIMENTS

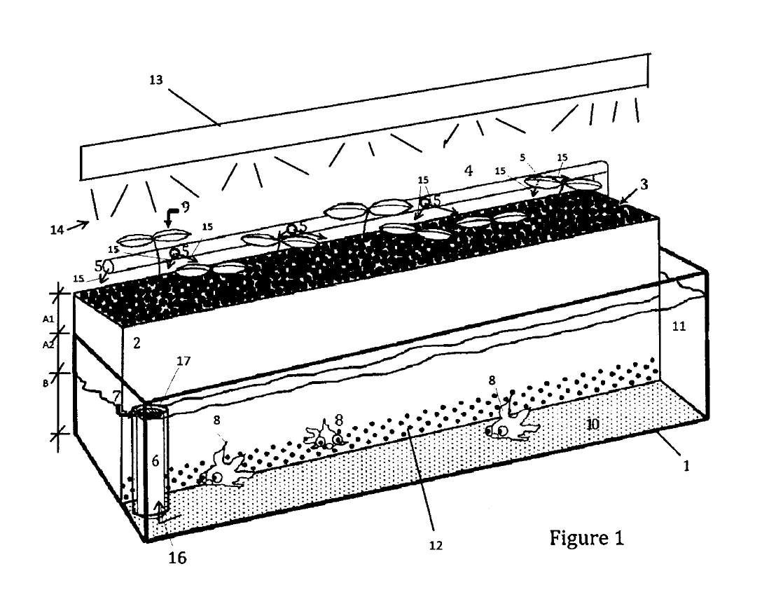

FIG. 1 shows the top-tier grow tank 1 of the preferred 3-tier embodiment of the vies of the invention. Tank 1 is a standard open-top glass aquarium.

FIG. 1 depicts components of the vies as follows:

1—aquarium tank,
2—grow bed,
3—porous media fill for grow bed,
4—inlet supply water tube,
5—supply water outlets providing a supply water spray or cascade over the grow bed 2 and the media fill 3,
6—tank outlet water tube providing, preferably, gravity fed outlet flow from the bottom of tank 1 over a drainage weir and into drainage tube outlet hole 7. The weir height sets the open water level in tank 1.
7—drainage hole,
8—freshwater aquatic species in open water environment,
9—actively growing plants,
10—tank 1 gravel bed
11—open water environment,
12—grow bed container perforations, preferably towards the bottom of tank 1,
13—light fixture,
14—grow light with on/off controls,
15—supply water cascade or spray from outlet holes 5,
16—bottom water feed with screen for water flow to and over dual standing drain,
17—overflow outer tube.

As can be seen once supply water in tank 1 of FIG. 1 reaches the weir height an overflow condition exists and supply water is drained by gravity flow to the tank below.

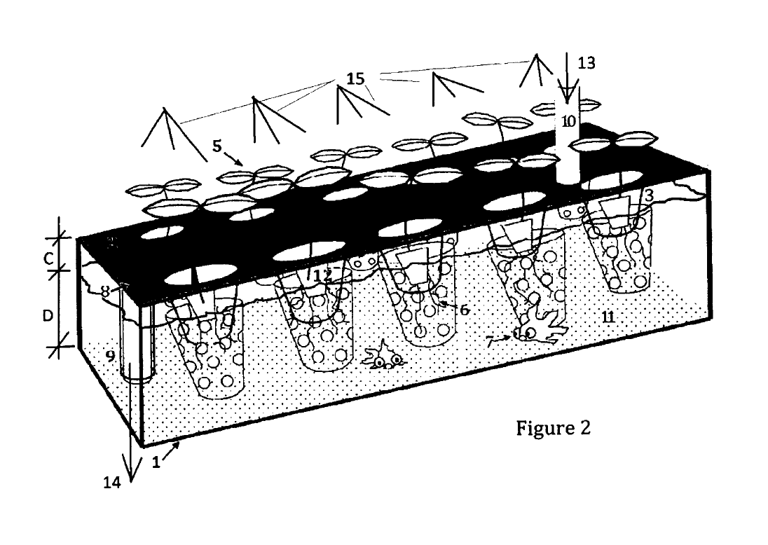

FIG. 2 shows the 2^{nd} tier grow tank of the preferred embodiment of the vies invention with the preferred hydroponic raft variant.

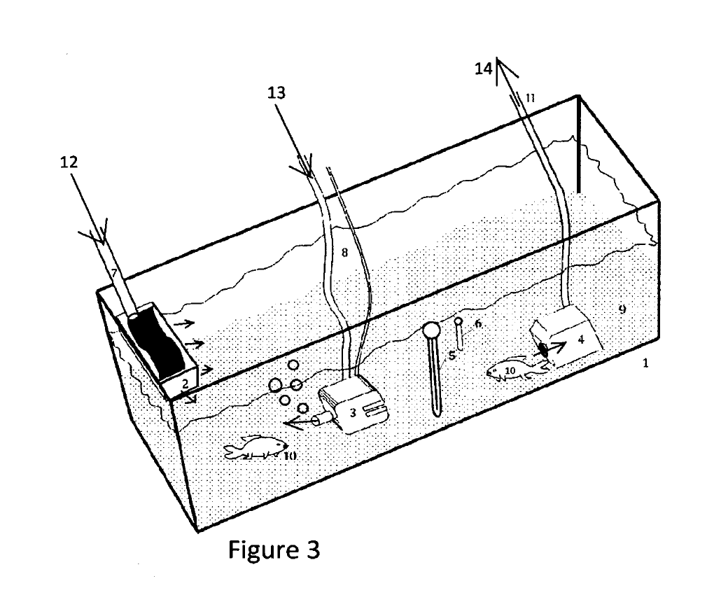

FIG. 2 depicts components of the preferred embodiment of the vies as follows:
1 2^{nd} tier aquarium tank,
2 hydroponic raft, either floating or, preferably as shown, supported on the tank 1,
   2.1 automatically maintained water level D,
   2.2 spacing C between water level and hydroponic mat in preferred embodiment of the 2^{nd} tier tank of the vies with mat supported on the edge of tank 1,
3 net pot for growth media
4 root guard container either floating or secured to the underside of raft 2. FIG. 2 shows a vertical separation between raft 1 and container 4 for ease of description,
5 plants,
6 plant roots growing in net pots 3 and extending in to guard containers 4,
7 freshwater aquatic species in open water environment,
8 drainage outlet hole providing a water level weir,
9 drainage water outlet,
10 inlet supply water tube from the above-mounted grow tank shown in FIG. 1,
11 gravel,
12 soil less hydroponic medium in net pots,
13 inlet water direction,
14 outlet water direction retention tank below (not shown in this Figure, see FIG. 3), and
15 on/off controlled grow light.

FIG. 3 shows the bottom tier retention tank of the preferred embodiment of the vies invention with components as follows:
1. glass aquarium tank,
2. returning water biofilter,
3. submersible air pump,
4. aquarium supply water pump,
5. optional aquarium heater,
6. optional aquarium thermometer,
7. inlet water tube for drainage of recirculating water by gravity from above,
8. air pump tube and electrical supply,
9. gravel,
10. freshwater aquatic species in open water environment,
11. supply water tube,
12. returning water flow,
13. air flow,
14. supply water for 2^{nd} and 3^{rd} tier tanks under pressure.

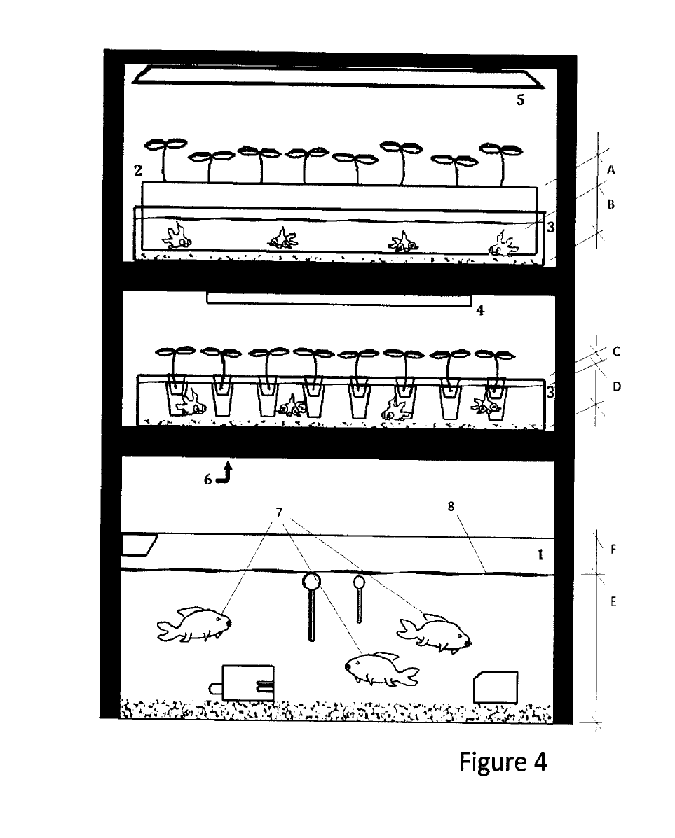

FIG. 4 shows an elevation of the preferred 3-tier embodiment of the vies invention including the tanks of FIGS. 1 through 3, with components as follows:
1. retention tank,
2. 2 grow bed on top tier
3. aquarium grown tanks on top and middle tier,
4. preferred LED lighting source for middle tier,
5. preferred grow light source for upper tier,
6. support structural framework,
7. larger freshwater aquatic species in open water environment, and,
8. retention tank water level, with
   a) water depth as at E, and
   b) safety margin as at F to prevent overflow.

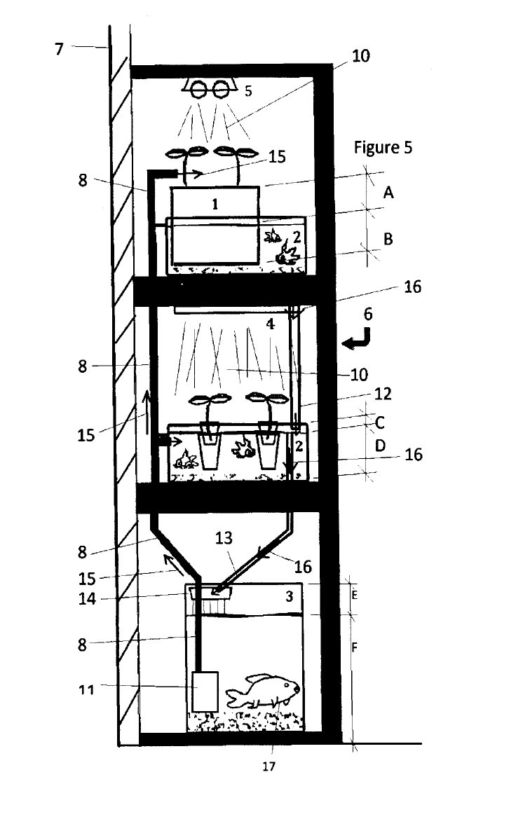

FIG. 5 shows an end view of the preferred 3-tier embodiment of the vies invention of FIG. 4 with components as follows:
1. upper tier grow bed,
   a) upwardly extending bed portion A,
   b) portion within tank 1, as at B,
2. aquarium tanks as grow tanks at upper and middle tier,
   a) water depth D,
   b) tank freeboard C,
3. retention tank,
   a) water depth F,
   b) safety freeboard E,
4. LED grow light fixture,
5. upper tier grow light fixture,
6. support structural framework secured to wall 7,
7. building wall,
8. water supply tube for pressurized supply water upwards flow,
9. not used in this Figure,
10. controlled cycle growth light,
11. pressurized supply water pump,
12. upper return water line for gravity flow,
13. lower return water line for gravity flow,
14. biofilter,
15. supply water upwards flow,
16. return flow direction, and
17. larger freshwater aquatic species in open water environment.

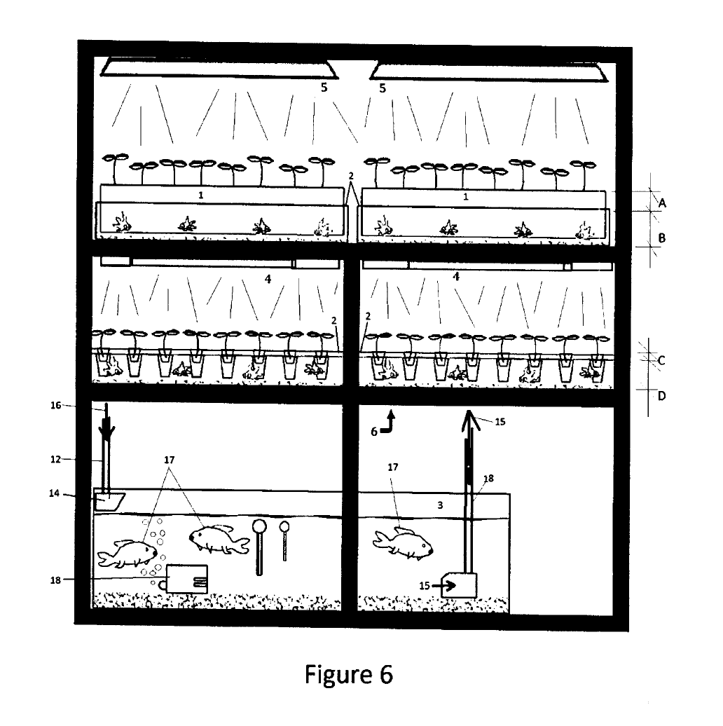

FIG. 6 shows an elevation view of the an alternative horizontally expanded 3-tier embodiment of the vies invention of FIGS. 1 through 5 with components as follows:
1. grow beds, upper grow tanks,
2. 4 spaced apart aquarium tanks at upper and middle tiers,
3. retention tank,
4. LED grow light fixture,
5. grow light fixture,
6. support structural framework with optional central support column,
   12. recirculating water gravity drain,
   13. not used
   14. biofilter,
   15. water supply to pump and pressurized water supply directions,
   16. return water flow direction,
   17. larger freshwater aquatic species in open water environment, and
   18. pressurized water supply line upwards.

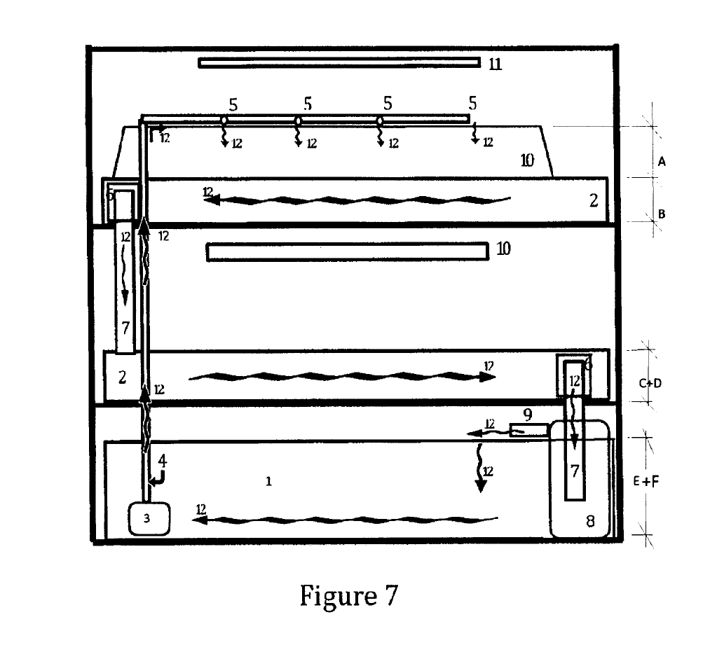

FIG. 7 shows an elevation showing preferred water flow of the preferred 3-tier embodiment of the vies invention including the tanks of FIGS. 1 through 4, with components as follows:
1. retention tank,
2. aquarium grow tanks at middle and upper tiers,
3. water supply pump,
4. pressurized water supply tube or line,
5. supply water outlet holes,
6. upper tier water drain inlet,
7. upper tier to middle tier water drain tube,
8. biofilter,
9. preferred overflow from biofilter 8 over retention tank edge with overall height E plus F (the retention tank nominal water depth),
10. LED grow light fixture,
11. grow light fixture,
12. recirculating water flow direction.

FIG. 8 shows an elevation section of the grow bed of FIG. 1 showing layered grow media in the grow bed of the preferred embodiment of the vies invention, with components as follows:
1. aquarium tank with overall height B,
2. layered earth module 2 acting as the grow bed extending above water surface in the grow tank by height A,
3. filter substrate media,
4. biochar,
5. porous media fill, and
6. optional decomposers.

The relative size of height A and height B in relation to the layers 3 through 6 in FIG. 8 is a matter of design choice.

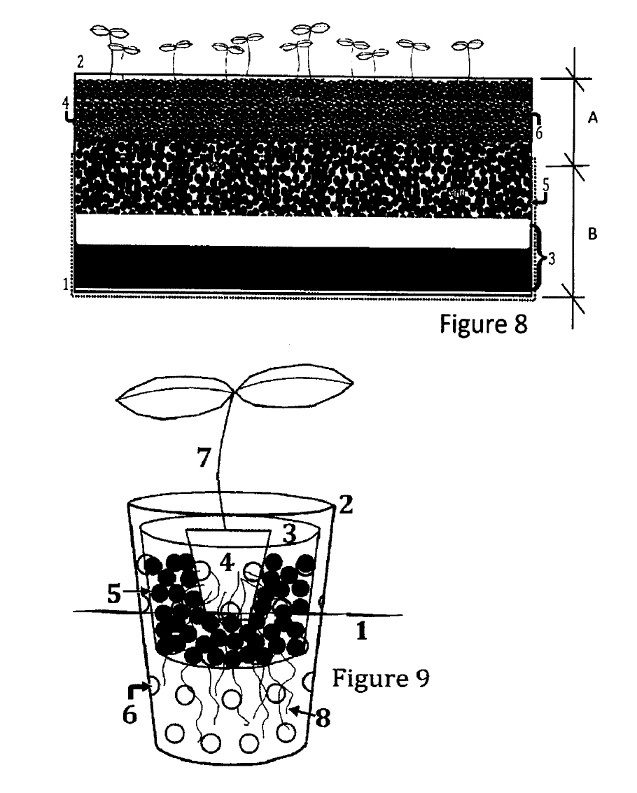

FIG. 9 shows a pictorial view of the net pot, container, media and growing plant of the preferred embodiment of the middle tier with the hydroponic rank of FIG. 2 showing layered grow media embodiment of the vies invention, with components as follows:
1. nominal water line,
2. perforated guard container secured to the raft (not shown),
3. net pot,
4. soil-less growth media,
5. porous media fill,
6. perforation holes for water exchange,
7. growing plants, and,
8. growing plant roots.

The scope of the patent protection sought herein is defined by the accompanying claims, as might be amended. The apparatuses and procedures shown in the accompanying drawings and described herein are examples.

Some of the components of the systems depicted herein have been depicted in just one system. That is to say, not all options have been depicted of all the variant systems. Skilled systems-designers should understand the intent that depicted features can be included or substituted optionally in others of the depicted apparatuses, where that is possible.

1. A vertically oriented indoor ecosystem comprising:
(a) a structural support framework permitting a plurality of grow and retention tanks to be stacked vertically on multi-level tiers;
(b) at least one water retention tank:
i. acting as the housing control tank to manage the quality and quantity of water f n the ecosystem and
ii. providing an environment for aquatic species,
(c) at least one grow tank supported on the support framework generally vertically above the water retention tank adapted:
i. to support at Least one grow bed within or upon the tank, and,
ii. to support an open water volume within the tank adapted to provide an open environment for aquatic species;
(d) a bank, of grow lights directed at each grow tank;
(e) an aquarium air pump to increase levels of oxygen in the water;
(f) at least one aquarium water pump to pump supply water from the retention tank up to the uppermost grow tank as a source of supply water for the grow bed;
(g) drainage adapted to permit supply water to flow into the grow bed and thence the grow tank to support plant growth in the grow bed;
(h) the water pump and the drainage acting to recirculate the supply water between the tanks:
(i) an overflow drain in each grow tank permitting maintenance of water Level and a gravity fed return of water to a tank below;
(j) water recirculating plumbing adapted to return supply water by gravity from upper tiers, sequentially or in parallel, into the retention tank;
(k) the water retention tank adapted to hold excess water when the aquarium water pump is not in, action;
(L) at least one grow bed in the grow tanks adapted to grow plants using supply water, nutrients included in the grow bed and energy from the grow Lights.

2. The indoor ecosystem of claim 1 further comprising a plurality of grow tanks vertically stacked above the retention tank.

3. The indoor ecosystem of claim 2 further wherein the plurality of grow tanks includes a three-tier vertically oriented indoor ecosystem including a middle tank with a hydroponic raft adapted to support plant growth media using supply water, supply water contained nutrients and energy from grow Lights, segregated from an open water volume providing an open water environment for aquatic species.

4. The indoor ecosystem of claim 2, wherein the grow bed includes a water barrier to separate the grow bed from a respective open water volume.

5. The indoor ecosystem of claim 4 wherein the grow bed includes an upper dry portion and a lower submerged portion,

6. The indoor ecosystem of claim 5 wherein the barrier is perforated to allow supply water to drain from the grow bed into the open volume of the grow tank.

7. The indoor ecosystem of claim 6 wherein the grow bed acts as a filter to filter out solid waste produced by aquatic species and plants.

8. The indoor ecosystem of claim 3 wherein the hydroponic raft is on or within the middle tan.

9. The indoor ecosystem of claim 8 wherein the hydroponic raft includes respective plant holes with pod nets to support partially dry and partially wet growth media.

10. The indoor ecosystem of claim 9 wherein the middle tank includes perforated covers between said pod nets and said open volume.

11. The indoor ecosystem of claim 10 wherein root space is provided between the pod nets and the perforated covers.

12. The indoor ecosystem of claim 1, wherein the grow bed contains at Least 50% biochar material and beneficial microbes to break down solids and provides for mineralization of solid waste and liquid nutrients.

13. The indoor ecosystem of claim 12 wherein the grown bed, also contains non-microbial organisms.

14. The indoor ecosystem of claim 13 wherein the organisms include worms.

15. The indoor ecosystem of claim 1 wherein water supply to each individual grow tank can be separately disconnected.

16. the indoor ecosystem of claim 1 wherein the grow tank includes at least. one inlet water tube and one water outlet tube, the outlet tube including an aquarium safe strainer guards preventing small aquatic species from flowing into a different tank and/or clogging the tube.

17. The indoor ecosystem of claim 9 wherein the net pot growth media includes a porous substrate media to support plants.
